(19) United States
(12) Patent Application Publication
(10) Pub. No.: US 2011/0036495 A1
(43) Pub. Date: Feb. 17, 2011

(54) METHOD OF MANUFACTURING A COMPLEX STRUCTURE MADE OF A COMPOSITE BY ASSEMBLING RIGID COMPONENTS

(75) Inventor: Jacques Cinquin, Igny (FR)

Correspondence Address: RATNERPRESTIA, P.O. BOX 980, VALLEY FORGE, PA, 19482, US

(73) Assignee: European Aeronautic Defence and Space Company EADS France, Paris (FR)

(21) Appl. No.: 12/672,563

(22) PCT Filed: Aug. 5, 2008
(86) PCT No.: PCT/EP2008/060302

§ 371 Date: Nov. 3, 2010

(30) Foreign Application Priority Data
Aug. 10, 2007 (FR) 0705810

(51) Int. Cl. B32B 37/02

(52) U.S. Cl. 156/307.1

(57) ABSTRACT

To produce a complex structure made of a composite, with assembled individual parts, a method includes the steps of: producing individual parts; producing assembly components, to ensure structural bonds between the individual parts, from fibers impregnated with a resin capable of curing by polymerization, comprising fins attached to a core that determine grooves, in order to receive edges, of the individual parts, subjected to a partial thermal cure to partially polymerize the resin and give the components a dimensional stability and thermoplastic properties; positioning of the individual parts and assembly components; raising the temperature to a thermoplastic forming temperature and applying pressure P in order to apply the fins to faces of the individual parts; and carrying out a complete thermal cure for polymerization of the resin of the assembly components.

### RELATED APPLICATIONS

This is a national phase application of International Application No. PCT/EP2008/060302, filed Aug. 5, 2008, which claims priority to French Application No. 0705810, filed Aug. 10, 2007, the contents of both applications being incorporated by reference herein in their entireties for all purposes.

### FIELD OF THE INVENTION

The present invention pertains to the area of manufacturing parts produced by assembling essentially rigid parts made of a composite. More particularly, the present invention pertains to the manufacture of such parts intended for highly strained structures whose final dimensions must be ensured with precision.

### BACKGROUND

Composites are widely used now to manufacture parts in numerous industrial areas, including structural parts, i.e., parts that have to absorb high stresses during their use. There are numerous composites, the most common ones being formed from fibers of varying lengths consisting of inorganic or organic materials (glass, carbon, Aramid, etc.) contained in a matrix formed by a hard organic resin.

If the complex structures must be produced from composites with shapes that make their production difficult in a single part, for example, for structures that are difficult to remove from the mold or for structures of very large dimensions compared to the production means available (molds, ovens, autoclaves, etc.), the solution employed most commonly is to produce parts of simpler shapes and smaller dimensions and to assemble these parts to manufacture the desired structure.

The assembly methods used for these structures made of composites are similar to those used to assemble structures made of metallic materials and comprise essentially the insertion of fixing means, for example, rivets, in assembly holes prepared in the parts which are assembled with a partial cover and/or with one or more joint bars.

With respect to the applications in the area of aeronautical constructions, in particular, these assembly methods have various drawbacks.

On the one hand, the presence of assembly holes in the highly strained structures makes it necessary to prepare local reinforcements, which lead, especially in case of composites, which have poor performance in the presence of a hole, to the necessity to increase the local thickness of the parts, which is disadvantageous for the weight of the assembly.

On the other hand, it is necessary in the majority of situations to interpose sealants between the assembled parts, which ensure sealing between the parts and sealing at the fixing means and which ensure the filling in of spaces between the assembled parts with certain limits considering the manufacturing tolerances of the parts.

This method of manufacturing structures, in particular, structures made of composites, is consequently detrimental to the weight of the structures thus assembled and is complicated and costly for an industrial process.

### SUMMARY

To simplify the industrial methods of manufacturing complex structures from composites without detriment to the weight of such structures, the present invention proposes an assembly method that uses assembly components made of a composite for assembling individual parts of the complex structure.

According to the method according to the present invention for manufacturing a complex structure from a composite comprising at least two individual structural parts assembled by means of at least one edge of one of the two individual parts, the method comprises the steps of
a) producing individual parts;
b) producing at least one assembly component intended to ensure a structural bond between the individual parts, said at least one assembly component
   b1) being made of a composite consisting of fibers impregnated with a resin capable of curing by polymerization in the course of hot curing;
   b2) comprising fins attached to a core and at least one pair of fins defining at least one groove intended to receive the edge of an individual part, whose groove bottom width at the level of the core corresponds more or less at any point to a thickness of the individual part along the edge having to be inserted into said groove;
   b3) being subjected to partial hot curing having the effect of partially polymerizing the resin of the assembly component, on the one hand, up to the stage at which the component has acquired a sufficient dimensional stability to make possible its handling and to guarantee its integrity during the subsequent assembly operations, and, on the other hand, up to an extent limited to a stage at which the resin possesses thermoplastic properties permitting plastic forming of the assembly component by raising the temperature;
c) relative positioning of the individual parts and of the assembly components according to their respective relative positions in the structure to be produced;
d) raising the temperature, at least locally, up to a thermoforming temperature of the fins and application of a pressure P to the fins to apply the fins to the faces of the individual parts; and
e) carrying out a complete hot curing for polymerizing the resin of the at least one assembly component.

To facilitate the insertion of the individual parts into the grooves of the assembly components and to facilitate the insertion of the edges of the parts into the bottoms of the grooves, the fins of one pair of fins forming a groove of an assembly component advantageously deviate from one another starting from the feet at the proximity of the core towards the free ends of said fins such that the groove is flared towards the free ends.

To improve the quality of assembly at the level of the junction between the fins and the individual parts, an adhesive film is preferably placed on the surfaces of the faces on which the fins will be supported.

To simplify the production of the assembly components and to avoid the use of complex molds for this production, advantageously if an assembly component must follow limited curves or twists, which can be obtained by using the elastic properties of the assembly component during its insertion, the assembly component being considered is produced in step b) without reproducing on this assembly component all the curves and/or twists in question that the assembly component will have in the preassembled or assembled position with the individual parts.

To produce various structures comprising various assembly configurations of individual parts, the assembly components have advantageously adapted shapes, for example, pairs of more or less aligned fins to ensure the assembly of two more or less aligned individual parts or of pairs of fins forming an angle to assemble two individual parts forming an angle at their common edges, or three or more pairs of fins having different orientations to assemble at least three individual parts.

In a particular shape meeting the needs of fixing an individual part by an edge to a face of another individual part, an assembly component is produced such that the fins of the pair of fins attached to the other individual part form a matching support surface to be applied to the face of said other part.

### BRIEF DESCRIPTION OF THE DRAWINGS

The method according to the present invention is described in reference to the figures, of which:

FIG. 1 shows an example of an assembly component before it is used at the beginning of a second step of the method;

FIG. 1a shows a detail of a section of the assembly component from FIG. 1;

FIG. 2 shows the positioning of the individual parts and of an assembly component in the course of a third step of the method;

FIG. 3 shows the individual parts and the assembly component from FIG. 2 in a preassembled position at the end of the third step of the method;

FIG. 3a shows a detail of a section of the assembly components from FIG. 3;

FIG. 4 shows the individual parts and the assembly component from FIG. 3 during the phase of bonding at the end of the fourth step of the method;

FIG. 4a shows a detail of a section of the components in the course of the fifth step of the method;

FIG. 5a shows a detail of a section of an end assembly;

FIG. 5b shows a detail of a section of an L-shaped assembly;

FIG. 5c shows a detail of a section of a Pi-shaped assembly;

FIG. 5d shows a detail of a section of a cross-shaped assembly; and

FIG. 5e shows a detail of a section of a variant of a Pi-shaped assembly.

### DETAILED DESCRIPTION

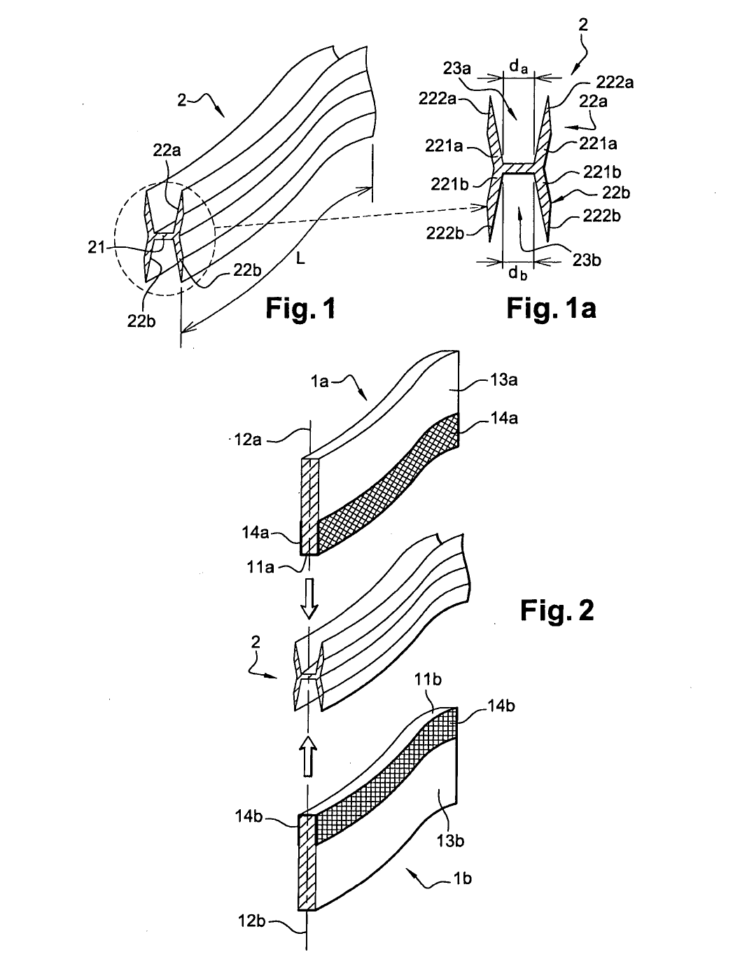

According to the method according to the present invention, whose steps are illustrated in FIGS. 1 through 4, a complex structure made of a composite is produced by assembling a plurality of single parts and/or subassemblies likewise made of a composite.

A composite is defined in the sense of the present invention as a material belonging to the class of composites commonly used to produce structures having to be both lightweight and resistant, such as those used to manufacture aircraft or other high-performance vehicles, comprising fibers of varying lengths of inorganic or organic materials (glass, carbon, Aramid, etc.) maintained in a matrix formed by a hard organic resin.

The single parts or subassemblies assembled to produce the structure belong to one of two principal types for the needs of the present invention.

A first type of single parts corresponds to the individual structural parts 1a, 1b which must be maintained in exact positions and connected to one another to form the complex structure. The parts of this first type are called individual parts.

The individual parts 1a, 1b have a more or less complex shape and are formed themselves, as the case may be, from a plurality of simpler parts preassembled previously according to any prior-art method or advantageously by the method according to the present invention if it is applicable.

For illustration of an embodiment of the method, particularly in FIGS. 1 through 4, the individual parts 1a, 1b are flat or slightly curved panels. The application of the method is not limited to these shapes of individual parts.

A second type of single parts corresponds to assembly components 2 which ensure the bonds between the individual parts 1a, 1b.

The bonds prepared according to the method by the assembly components are so-called structural bonds, i.e., bonds that are capable of ensuring the transmission of stresses of intensities equivalent to those of the stresses for which the so-called individual parts are designed between the individual parts.

According to the method, the individual parts 1a, 1b are produced, in a first step, not shown, advantageously from composites according to conventional methods.

For example, depending on the stresses and rigidities necessary for the structure to be produced, an individual part is produced according to a technology utilizing fibers, arranged in sheets or as woven fibers, previously impregnated with a noncured resin, so-called prepregs, arranged on a form or in a mold and subjected to a curing operation, which cures the resin by polymerization. The parts thus produced have stable shapes corresponding, in general, to the desired final shapes of said parts, said parts comprising, as the case may be, associated components, for example, stiffeners, which can be produced at the same time as the parts or can be joined with and attached to the parts by known means.

Another example of producing an individual part comprises the cutting off of blanks in a heat-formable composite and shaping said blanks.

A heat-formable composite is a composite whose matrix is formed by a resin that is cured at the normal temperature at which the structure is used but which can be plastically deformed by raising the temperature in the course of a forming process.

Another example of producing an individual part comprises, according to the so-called prior-art RTM method or any other derived method such as film infusion, of impregnating the dry fibers placed in advance into a mold with a liquid resin injected into said mold, which said resin is then cured by polymerization.

The assembly components 2 are produced in a second step of the method, illustrated in FIG. 1.

An assembly component 2, designed in a simple form as shown in FIG. 1 and in FIG. 1a to assemble two individual parts 1a and 1b comprising an edge 11a and 11b, respectively, which is more or less common when said two parts are assembled, comprises a section, i.e., an elongated component having an essentially constant or slightly changing standard section, whose characteristic length L corresponds more or less to the common length of the assembled individual parts.

The assembly component 2 comprises, on each of the two opposite sides of a longitudinal bonding core 21, a pair of longitudinal fins 22a, 22b attached to the core 21 at the level of a respective fin foot 221a, 221b for each of said fins and forming a groove 23a, 23b, respectively.

The assembly components are produced, by means of molds or forms adapted to the shapes of said assembly components, from a thermosetting composite, i.e., a composite whose matrix is a resin capable of curing by polymerization in the course of a phase of curing by raising the temperature or by a method using preimpregnated fibers or by an RTM method of transferring resin into the dry fibers.

The molds or forms used, not shown, to produce an assembly component are such that
a groove bottom width da, db separating the fin feet 221a, 221b of one fin pair 22a, 22b at the level of the core 21 of assembly component 2 is more or less equal at any point of the length of said assembly component to a thickness of the individual part 1a, 1b with which said assembly component must be assembled;
the two fins 21a, 21b of one pair of fins preferably deviate more or less from each other, advantageously more or less symmetrically in relation to a middle plane 12a, 12b of the individual part 1a, 1b with which the assembly component must be assembled, from the fin feet 221a, 221b towards the free ends 222a, 222b of the fins, opposite said feet in relation to the core 21, forming a section having a flared geometry in the direction of an opening of groove 23a, 23b;
the fins 22a, 22b of each pair of fins are oriented in space to correspond to the desired relative orientations of the individual parts 1a, 1b intended to be assembled by the assembly component.

In one particular embodiment, if the assembly component 2 must follow, in conformity with the individual parts 1a, 1b to be assembled, curvatures with relatively small radii which could not be obtained without a significant defect by a subsequent arching operation of said assembly component, the molds or forms used to produce the assembly component reproduce the curvatures in space that said assembly component will have in a final position in the structure to be manufactured to the extent needed.

In a first phase of the second step of the method, the fibers preimpregnated with resin are placed or dry fibers are placed and the liquid resin is injected onto the fibers according to the method used, using molds or forms corresponding to the assembly component 2 to be manufactured.

In a second phase of the second step of the method, the resin of the fibers is subjected to a first phase of hot curing, a so-called partial hot curing, which has the effect of partially polymerizing the resin, such that:
at an ambient temperature around 20° C. in a workshop, it imparts an adequate rigidity to the component manufactured enabling it to more or less preserve its shape when it is not subjected to significant mechanical stresses and to be stored over long periods of time, on the time scale of the industrial manufacturing methods considered, without significant chemical changes taking place in the resin;
a subsequent temporary temperature increase leads to a reduction of the rigidity of the composite forming the component, conferring on it physical and rheological characteristics similar to those of a thermoplastic composite.

Said partial hot curing phase is, for example, a hardening hot curing of the thermosetting material, which curing is normally used to polymerize and cure the composite and which is interrupted before complete gelling of the resin, i.e., the point in the polymerization process at which the density of the three-dimensional network of molecular chains within the resin has reached a stage at which said resin does not have any longer the sufficient characteristics for the conventional use of preimpregnated fibers. The moment at which it is desirable to interrupt the hot curing depends on the type of resin used. It is determined, for example, experimentally close to the gelling point of said resin.

The method consequently utilizes a so-called thermoplasticity property that the thermosetting materials, which are normally insensitive to heat after polymerization (within the limits of the chemical stability of the polymerized resin) temporarily have in the course of the normal curing process by polymerization.

The partial hot curing consists of raising the temperature of the resin by a conventional method to bring about curing of the resin, but the polymerization process is interrupted in this case before complete curing of the resin by returning to the ambient temperature.

At this stage of the method, in particular, the assembly component 2 essentially preserves at ambient temperature the curvatures that were conferred on it by the mold or form in which it was produced and the fins 22a, 22b are sufficiently stable not to collapse under their own weight and during the subsequent handling.

Conventional methods used to manufacture parts from composites are advantageously used to produce an assembly component 2; for example, preimpregnated fibers are placed on the molds having the desired outer shape for said assembly component. This operation is carried out, for example, by draping manually or by means of a machine for draping sheets of preimpregnated fibers.

The assembly component 2 is then subjected to the partial hot curing, generally with the application of a pressure on the composite placed in the molds.

In a third phase of the second step of the method, the assembly component is removed from the mold in which it was subjected to the partial hot curing by polymerization.

After returning the component to ambient temperature, the polymerization of the resin is slowed down greatly and the assembly component 2 can be stored for at least 6 months, according to the tests performed, under ambient conditions if the temperature is maintained below 40° C. and the relative humidity is lower than 60% without its so-called thermoplastic properties undergoing any change more or less.

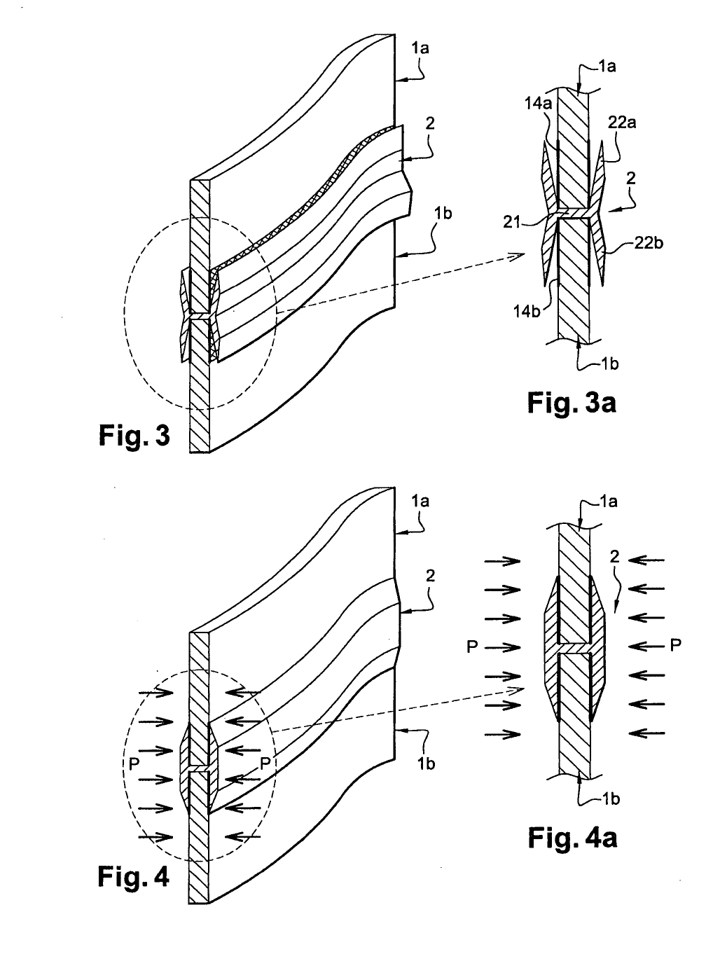

In a third step of the method corresponding to FIG. 2 and to FIG. 3, the individual parts 1a, 1b, at least two parts, are placed and maintained, by means of tools, not shown, relative to one another in relative positions corresponding to the relative positions that the individual parts must have in the assembly, the so-called preassembled position.

During this step of placing the individual parts 1a, 1b, the assembly component or assembly components 2 produced in the course of the second step of the method are also put in place such that the edges 11a, 11b of the individual parts 1a, 1b that must be assembled are inserted into the grooves 23a, 23b formed by the pairs of fins 22a, 22b of said assembly components, said edges of the individual parts inserted into said grooves coming more or less into contact on the cores 21 of the assembly components 2.

Due to the partial hot curing to which the assembly components 2 were previously subjected, said assembly components have, on the one hand, a rigidity at ambient temperature and a stability that makes it possible to handle them without particular means, such that the molds or cores carrying uncured preimpregnated fibers necessary in the prior-art methods, and, on the other hand, said assembly components have a sufficiently low rigidity to easily conform to the desired shape during their positioning and to be maintained in the desired positions during the various preassembly operations, contrary to the methods in which completely polymerized components are assembled, which are too rigid to undergo more or less a deformation.

At the end of this step of the method, an assembly of individual parts 1a, 1b, at least two individual parts, and assembly components, at least one, are placed in positions corresponding to the positions that said components and sections must have in the assembly to be manufactured.

However, as is illustrated in detail in FIG. 3a, the fins 22a, 22b of the assembly components 2, which are relatively rigid at the temperature at which they are used, a priori the ambient temperature of a shop in which parts made of composites are manufactured, are not in contact at this step of the method with the faces 13a, 13b of the individual parts 1a, 1b because of the flared geometry of the grooves 23a, 23b formed by the pairs of fins, which makes it, on the one hand, particularly easy to insert the edges 11a, 11b of the individual parts 1a, 1b into the grooves of the assembly components 2 up to the core 21 of said assembly components, and, on the other hand, it causes as a consequence that the structural bond between an individual part 1a, 1b and an assembly component 2 into which said individual part is inserted does not have a significant contact area.

In a fourth step of the method, the temperature of the individual parts and of the assembly components in the preassembled position is raised, at least locally in the zones affected by the assembly sections, a value at which the composite of the assembly components becomes plastic and can be deformed, and a pressure P is applied to the fins 22a, 22b of the assembly components such that said fins are brought closer to the faces 13a, 13b of the individual parts 1a, 1b, as is shown in detail in FIG. 4a.

In a fifth step corresponding to FIG. 4, a second complete hot curing is performed by polymerization such that the material of the assembly components having undergone partial hot curing in the course of the second step of the method is cured by complete polymerization of the resin.

The pressure applied to the fins 22a, 22b is advantageously maintained during this complete hot curing such that the fins intimately adhere to the faces 13a, 13b of the individual parts 1a, 1b, with which they are in contact.

Complete polymerization is defined as the degree of polymerization of the resins used that is attained in the conventional processes when it is considered that the composite has acquired stable mechanical properties admitted to be final in regard to the intended use of the parts.

This adhesion by polymerization under pressure is advantageously improved by the addition of adhesive films 14a, 14b placed, before the third step of the method, on the faces 13a, 13b of the individual parts 1a, 1b at the level of surfaces that have to be in contact with the fins 22a, 22b.

The pressures P applied to the fins 22a, 22b during these fourth and fifth steps of the method may be carried out by any means capable of applying a distributed and regular pressure.

The pressure is advantageously brought about by means of flexible bladders, not shown, attached to the zones where the pressure must be applied and in which bladders a partial vacuum is generated such that the atmospheric pressure applies the desired pressure.

In other embodiments of this step of the method, the pressure is applied against the support surfaces of the molds by means of a countermold or a device applying pressure against the mold, advantageously a pressurizing device comprising hydrostatic means because of the homogeneous pressure distribution brought about by such means.

In a preferred embodiment of the assembly components 2, the fins 22a, 22b have variable thicknesses between their feet 221a, 221b and their free ends 222a, 222b.

Thus, a fin 22a, 22b has a first thickness at the foot, a so-called socket thickness, and a second thickness at the free end, a so-called end thickness, which is smaller than the socket thickness.

The thickness reductions of a fin 22a, 22b between the socket thickness and the end thickness are brought about during the production of the assembly section by reducing the number of plies of fibers of composite forming the fin from its foot 221a, 221b towards its free end 222a, 222b.

This reduction of the number of plies forming the fin is advantageously adapted to the flux of forces transmitted between the fins and the individual part to which said fins are attached, the individual part being progressively relieved and increasing forces being transmitted in the fins from the free ends towards the feet.

The free ends 222a, 222b of the fins 22a, 22b are advantageously terminated by chamfers, which ensure both the cleanness of the junction between the faces 13a, 13b of the individual part and the fins and protect the free ends 222a, 222b of the fins.

As it was already stated before, the detailed example described illustrates only one particular form of assembly components and application associated with the method.

Numerous other shapes of assembly sections are possible within the framework of the application of the method according to the present invention.

An assembly section 2 is produced in practice in the course of the second step of the method depending on the shapes and the number of individual parts that must be maintained by the assembly component.

Besides the dimensions of the assembly component, the fins, in particular, which are adapted to the dimensions of the various individual parts, an assembly component has as many pairs of fins as the individual parts maintained by said assembly component, the same assembly component comprising, as the case may be, a variable number of pairs of fins depending on the position over the length of said assembly component.

Each pair of fins 22a, 22b defines a mean orientation 12a, 12b, corresponding to a local middle plane of the individual part 1a, 1b that must be maintained by said pair of fins and forms with the mean orientation of another pair of fins any angle defined at any point by the desired junction angles for the individual parts.

According to the desired connection of the individual parts, an assembly component is linear or curved, having a single curvature or a double curvature, and/or twisted, i.e., the direction of the mean orientation of a pair of fins is variable as a function of position, depending on its position over the length of the assembly component.

However, if the curvatures or twists are small compared to the rigidity of the assembly component 2 obtained after the partial hot curing in the second step of the assembly component, said small curvatures and twists are advantageously ignored during the second step of the method to simplify the production of the assembly component 2 and said assembly component is deformed more or less elastically during preassembly during the third step of the method.

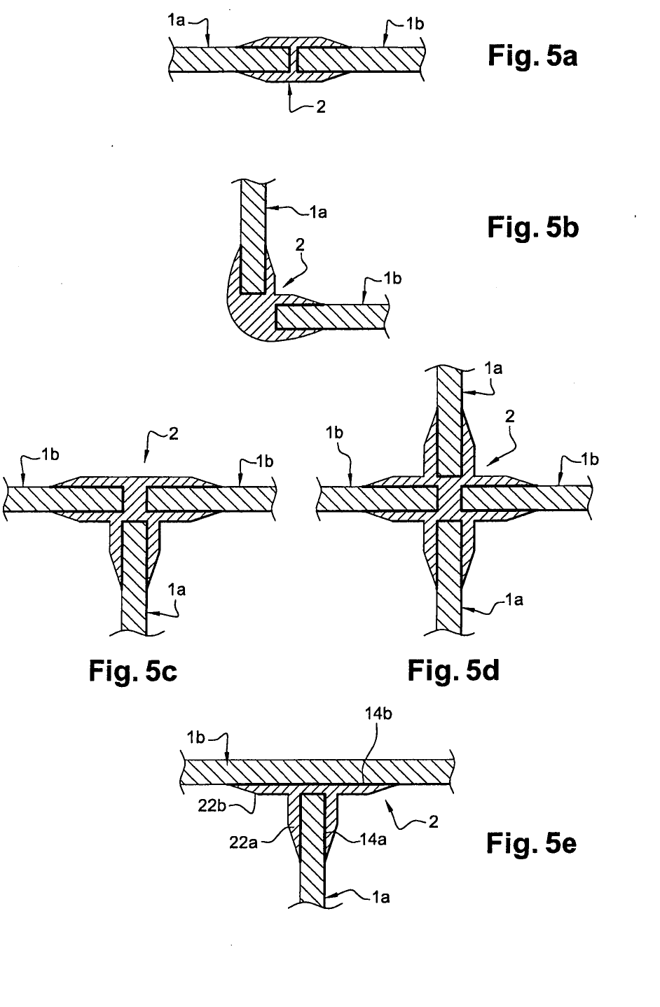

FIGS. 5a through 5e illustrate nonlimiting examples of sections of single assembly components.

In the so-called end assembly of two individual parts, which is shown in FIG. 5a, the assembly section has the shape of an H in which the pairs of fins are oriented in essentially opposite mean directions.

This end assembly corresponds to that used for the detailed description of an embodiment of the method according to the present invention.

For the so-called angular assembly of two individual parts, which is shown in FIG. 5b, the assembly component has an L-shape, in which the pairs of fins are oriented in mean directions forming a desired angle A.

For the so-called end assembly of three individual parts, which is shown in FIG. 5c, the assembly section has a Pi shape in which the pairs of fins are oriented in mean directions oriented more or less opposite for two of them and in a direction forming a desired angle B for the third one.

For the cross-shaped assembly of four individual parts, which is shown in FIG. 5d, the assembly section has the shape of an X in which the pairs of fins taken two by two are oriented in more or less opposite mean directions and a group of two pairs of fins forms an angle with the other group of two fin pairs.

In a shape close to the Pi shape in embodiment, illustrated in FIG. 5e, a first individual part is assembled by an edge of said first individual part on a face of a second individual part. In this assembly the fins of the assembly section that are located on the side of the face of the second individual part are made open such that the contact surfaces of said fins that have to adhere to said face of the second piece are supported on said face in the fifth step of the method.

Various combinations of different assembly examples illustrated or of other assemblies embodied according to similar principles are also possible within the framework of the present invention.

The method according to the present invention is applied advantageously but in a nonlimiting manner to the assembly of individual parts having the shapes of panels, for example, to embody box-type structures such as aircraft wing boxes.

1. A method of manufacturing a complex structure from a composite, comprising at least two individual structural parts assembled by at least one edge of one of said two individual structural parts, said method comprising the steps of:
a) producing the individual structural parts;
b) producing at least one assembly component capable of ensuring a structural bond between the individual structural parts, said at least one assembly component:
b1) being made of a composite containing fibers impregnated with a resin capable of curing by polymerization in the course of hot curing;
b2) comprising fins attached to a core, at least one pair of fins defining at least one groove, intended to receive said edge of an individual structural part, whose groove bottom width at the level of the core corresponds more or less at any point to a thickness of the individual structural part along the edge that has to be inserted into said groove; and
b3) being subjected to a partial hot curing leading to partial polymerization of the resin of the assembly component, on the one hand, up to a stage at which said component has acquired a sufficient dimensional stability to make possible its handling and to guarantee its integrity during the subsequent assembly operations, and, on the other hand, said polymerization being limited to a stage at which the resin has thermoplastic properties permitting plastic forming of said assembly component by raising its temperature;
c) positioning the at least two individual structural parts and the at least one assembly component corresponding to their respective relative positions in the structure to be manufactured;
d) raising the temperature, at least locally, up to a thermoforming temperature of the fins and applying a pressure P to said fins to apply said fins to the faces of the individual parts; and
e) carrying out a complete hot curing by polymerization of the resin of the at least one assembly component.

2. A method in accordance with claim 1, in which the fins of a pair of fins forming the at least one groove of the at least one assembly component deviate from each other from the feet at the proximity of the core towards the free ends of said fins such that said groove is flared towards said free ends.

3. A method in accordance with claim 1, in which an adhesive film is placed on the surfaces of the faces on which the fins will be supported.

4. A method in accordance with claim 1, in which the assembly component is produced in step b) without all the curvatures and/or twists that said assembly component will have in the position in which it is preassembled or assembled with the individual structural parts being reproduced on said assembly component.

5. A method in accordance with claim 1, in which at least one assembly component is produced with two pairs of opposite fins to ensure that the two individual structural parts are more or less aligned.

6. A method in accordance with claim 1, in which at least one assembly component is produced with pairs of fins having different mean orientations to ensure the assembly of the two individual structural parts forming an angle at their common edges.

7. A method in accordance with claim 1, in which at least one assembly component is made with at least three pairs of fins with different mean orientations to ensure assembly of at least three individual parts.

8. A method in accordance with claim 1, in which at least one assembly component is produced to ensure the assembly of the two individual structural parts, one individual structural part being assembled by an edge of said part on a face of the other individual structural part, the fins of the pair of fins attached to said other individual structural part forming a support surface conformed to be applied to the face of said other individual structural part.
